(19) United States
(12) Patent Application Publication
(10) Pub. No.: US 2005/0135865 A1
(43) Pub. Date: Jun. 23, 2005

(54) Pen with projector lamp

(76) Inventor: Jin En Cui, Sanshui City (CN)

Correspondence Address: RABIN & BERDO, P.C., Suite 500, 1101 14th Street, N.W., Washington, DC, 20005, US

(21) Appl. No.: 10/984,938

(22) Filed: Nov. 10, 2004

(30) Foreign Application Priority Data
Dec. 18, 2003 (CN) 200320119342.2

(51) Int. Cl. B43K 29/10

(52) U.S. Cl. 401/195; 362/118

(57) ABSTRACT

This invention makes relates to pen with projector lamp, including a pen refill, a pen holder, and a connecting tube. The connection between the front end of the said connecting tube and the back end of the said pen holder is the detachable one. A lens is installed in the back end of the said connecting tube; and a battery, a button and an illuminator are installed sequentially and form a circuit in the front end of the connecting tube. The said button is installed in the sidewall of the connecting tube, and a film with pictures and characters is installed between the said illuminator and the lens. When the button is pressed, the said illuminator can give off rays and projects out the pictures and characters printed on the film, so as to produce advertising effectiveness. The invention can effectively draw people's attention, thereby it possesses favorable advertising effectiveness.

### FIELD OF THE INVENTION

The present invention relates to a kind of pen, especially a pen with projector lamp, which possesses advertising effectiveness.

### BACKGROUND OF THE INVENTION

The known pens generally don't possess projecting function, and the pens are always printed with pictures, characters and trademarks on the tube-shaped penholders in order to produce advertising effectiveness. However, the tube-shaped penholders are so small that the pictures, characters and trademarks on them are not so conspicuous, and the advertising effectiveness is difficult to be promoted. In addition, the printed pictures, characters and trademarks have no lighting effect, so it is difficult for them to draw people's attention.

### DESCRIPTION OF THE INVENTION

The object of the present invention is to provide a kind of pen with projector lamp so as to bring favorable advertising effectiveness.

In order to achieve the object, the present invention provides a pen with projector lamp including a pen refill and a penholder, the pen further includes a connecting tube, the front end of which is detachably connected to the back end of the said penholder, in the back end of which a lens is installed, and in the front end of which a battery, a button and an illuminator are arranged sequentially and form a circuit; the said button is installed in the sidewall of the connecting tube, and a film with pictures and characters is installed between the said illuminator and lens. When the button is pressed down, the said illuminator gives off rays and projects the pictures and characters on the film by means of so as to produce advertising effectiveness.

In order to facilitate the installation and use of the pen, the said illuminator of this invention is embodied as a LED. The back end of the said connecting tube is equipped with an installation tube, and the connection between the connecting tube and the installation tube is a detachable one; the said lens is installed in the back end of the installation tube by means of a snap ring; the said film with pictures and characters is installed in the front end of the connecting tube by means of a snap splicing sleeve, and the connection between the snap splicing sleeve and the installation tube is also a detachable one.

The said detachable connections of the present invention are the screwed ones for facilitating the installation between the penholder and the connecting tube, the connecting tube and the installation tube, as well as the snap splicing sleeve and the installation tube.

The invention has the following advantages: it can realize advertising effectiveness through the projection produced by the illuminator, the lens and the film with pictures and characters, which are installed in the connecting tube. It can effectively draw people's attention, thereby it possesses favorable advertising effectiveness.

### BRIEF DESCRIPTION OF THE DRAWINGS

The present invention is explained in more detail below with reference to the embodiments and drawings, in which:

FIG. 1 is a schematic view showing the structure of one preferred embodiment of this invention.

FIG. 2 is a schematic view showing the installation of illuminating part of one preferred embodiment of this invention.

FIG. 3 is a schematic view showing the operating state of one preferred embodiment of this invention.

### DESCRIPTION OF THE PREFERRED EMBODIMENT

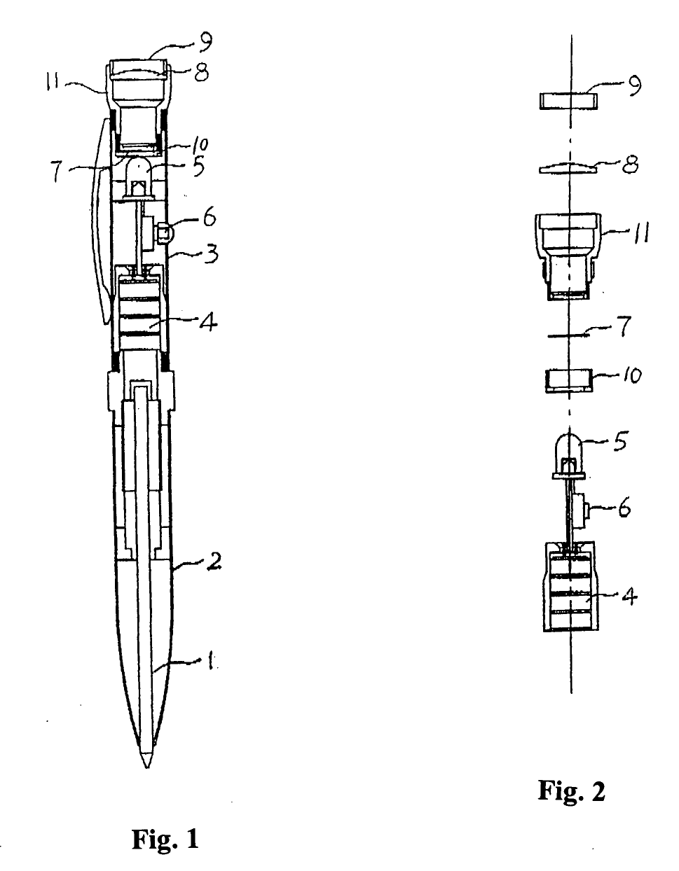

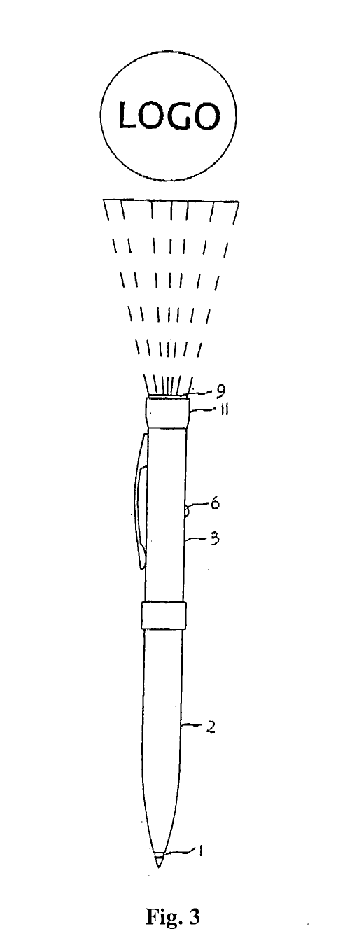

FIG. 1 to FIG. 3 shows the preferred embodiment of this invention, including pen refill 1, penholder 2, connecting tube 3, battery 4, LED 5, button 6, film 7 with pictures and characters, lens 8 and snap ring 9. As shown in FIG. 1, the pen refill 1 is placed in the penholder 2, and the connection between the front end of the connecting tube 3 and the back end of the pen holder 2 is the screwed one; the film 7 with pictures and characters is the one printed with a logo (as shown in FIG. 3). As shown in FIG. 1 and FIG. 2, the battery 4, the button 6 and the LED 5 are arranged sequentially and form a circuit in the front end of the connecting tube 3, and the button 6 is installed in the sidewall of the connecting tube 3; the installation tube 11 is fixed at the back end of the connecting tube 3. The connection between the connecting tube and the installation tube is the screwed one. The lens 8 is arranged in the back end of the installation tube 11 by mean of the snap ring 9. The film 7 with logo between LED 5 and lens 8 is installed in the front end of the installation tube 11 by mean of the snap splicing sleeve 10, and the connection between the snap splicing sleeve 10 and the installation tube 11 is the screwed one. In this way, the LED 5 can project the logo through the film 7 and the lens 8 sequentially.

While in operation, press the button 6, LED 5 gives off rays and projects the character of the logo printed on the film 7 with logo by lens 8, then come out the image shown in the FIG. 3. When the parts needs detaching or replacing, the following such as the connection tube 3 and the penholder 2, the installation tube 11 and the connecting 3, or the snap splicing sleeve 10 and the installation tube 11 can be detached. By replacing films 7 with different pictures and characters, different images can be seen.

1. A pen with projector lamp, including a pen refill and a penholder, characterized in that the pen further includes a connecting tube, the front end of which is detachably connected to the back end of the said penholder, in the back end of which a lens is installed, and in the front end of which a battery, a button and an illuminator are arranged sequentially and form a circuit; the said button is installed in the sidewall of the connecting tube, and a film with pictures and characters is installed between the said illuminator and lens.

2. The pen with projector lamp according to claim 1, wherein the said illuminator is embodied as a LED.

3. The pen with projector lamp according to claim 1, wherein the back end of the said connecting tube is equipped with an installation tube, and the connection between the connecting tube and the installation tube is a detachable one; the said lens is installed in the back end of the installation tube by means of a snap ring; the said film with pictures and characters is installed in the front end of the connecting tube by means of a snap splicing sleeve, and the connection between the snap splicing sleeve and the installation tube is also a detachable one.

4. The pen with projector lamp according to claim 1, wherein the detachable connections are the screwed ones.

5. The pen with projector lamp according to claim 3, wherein the detachable connections are the screwed ones.
